(19) United States
(12) Patent Application Publication
(10) Pub. No.: US 2023/0098496 A1
(43) Pub. Date: Mar. 30, 2023

(54) ALL SOLID-STATE ELECTROLYTE COMPOSITE BASED ON FUNCTIONALIZED METAL-ORGANIC FRAMEWORK MATERIALS FOR LITHIUM SECONDARY BATTERY AND METHOD FOR MANUFACTURING THE SAME

(71) Applicant: SOLID ULTRABATTERY INC., Waterloo (CA)

(72) Inventor: Zhongwei CHEN, Jinhua (CN)

(21) Appl. No.: 17/910,198

(22) PCT Filed: Mar. 22, 2020
(86) PCT No.: PCT/CN2020/080537

§ 371 Date: Sep. 8, 2022

(51) Int. Cl. H01M 10/0565; H01M 10/0525; H01M 10/058

(52) U.S. Cl. CPC H01M 10/0565; H01M 10/0525; H01M 10/058; H01M 2300/0091; H01M 2300/0082

(57) ABSTRACT

A safe all-solid-state lithium secondary battery using a functionalized Metal-organic framework (MOFs)-based sol-id-state electrolyte composite and methods for manufacturing that electrolyte are provided. Specifically, that solid-state electrolyte composite includes MOFs material and traditional polymer, which are mixed and electrospining into a solid thin film. The solid-state electrolyte could significantly reduce the safety risk as well as enhance the Li+ conductivity rate through reducing the degree of crys-tallinity for polymer and coupling the polymer within the oriented and uniform pore structures in MOFs, thus improving the ionic conductivity and enhancing the Li batteries performance. The procedure involves only one step, and it is expected to be easy for scale-up.

### FIELD OF THE INVENTION

The present invention related to all-solid-state electrolyte composite, all-solid-state secondary Li battery and a method for manufacturing the same. A solid film composed of functionalized metal-organic framework materials and polymers, which was fabricated by electrospinning.

### BACKGROUND OF THE INVENTION

Organic electrolytes have been widely applied in secondary lithium batteries, which employ the lithium metal or alloy as the electrode material, such as Li-ion battery, Li—S battery.

However, the safety issues, like inflammable, liquid leakage and short circuit temperature rise usually lead to cell death and even catch fire. Therefore, it remains a great challenge for further improving the safety and reliability.

All-solid-state secondary lithium batteries in which solid-state electrolytes instead of liquid electrolytes are used are attracting more attention in recent years. The non-inflammability of solid-state electrolyte could significantly solve the safety issues. Furthermore, the positive and negative electrodes and solid-state electrolyte could be disposed in series in a direct arrangement, thus possibly increasing the battery energy density, compared to organic electrolyte.

The solid-state electrolytes can be generally divided into three categories, including inorganic ceramic electrolyte, organic polymer electrolyte and inorganic-organic hybrid electrolyte.

The ion conductivity of inorganic ceramic electrolyte is much higher than that of organic electrolyte. Conversely, the interface resistance between electrodes and inorganic electrolyte is high due to the poor contact.

The organic electrolyte, such as PEO, PMMA, PAN, PVDF and PVDF-HEP usually has a low ion conductivity at room temperature. A key challenge lies in how to improve the room temperature ion conductivity thus requiring to be addressed.

The inorganic-organic hybrid electrolyte, which combines both the high ion conductivity of inorganic electrolyte and the good interface contact using organic electrolyte may be a better approach for the design of all-solid-state battery.

In the above described all-solid-state-electrolyte, the formation of any electrolyte materials containing a specific polymer compound or like, methods for manufacturing the solid-state-electrolyte are proposed. For example, US2018/0277892A1 describes a solid-state electrolyte composite containing a polymer having an SP value of 10.5 cal^{1/2} cm⁻ 3/2 or more, an electrode sheet for the all-solid-state secondary Li-ion battery and the method for manufacturing the same. Furthermore, US2011/0129273A1 describes a safe all-solid-state lithium secondary battery using a sulfide-based solid electrolyte material. In addition, CN104779415A describes an all-solid-state-electrolyte containing the cross-linked polymer as well as the method of cross-linking silane coupling agent and polyethylene glycol.

### SUMMARY OF THE INVENTION

The purpose of the present invention is to overcome the defects of the existing battery electrolyte, and provide a solid electrolyte material and a preparation method thereof. The electrolyte material is a solid electrolyte material obtained by blending a metal-organic frame material with a polymer. The application of the metal-organic frame material and polymer blended solid electrolyte material in lithium-ion batteries and lithium-sulfur batteries can make the batteries have excellent stability and safety, enhance Li⁺ conduction rate, and thereby improve battery performance. And compared with the liquid electrolyte, the safety performance of the solid electrolyte material is greatly improved. In addition, the preparation method of the invention has simple steps and high reproducibility, and is suitable for industrial production.

The object of the present invention and its technical problems are solved by adopting the following technical solutions. A solid-state electrolyte material according to the present invention comprising a functionalized metal-organic framework material (MOFs) and a polymer material. The weight percentage, the content of the functionalized metal-organic framework material is 0.1%-20%, preferably 1.5%-10%, and the polymer material content is 80%-99.9%.

The MOFs are selected from one or more of ZIF-8, ZIF-67, MOF-5, UIO-66, UIO-67, MIL-100 (Fe), MIL-53 (Al), DUT-5, DUT-4, One or more of MIL-101 (Cr), MIL-10INDC, HKUST-1, PCN-14; and functionalized by a functional group including one of sulfonate and its derivative, sulfonamide and its derivative, tetrahedron borate and its derivative. Or more.

The polymer material of present application is selected from one or more of polyethylene oxide group, polymethyl methacrylate group, polyacrylonitrile group, polyvinylidene fluoride, copolymer of polyvinylidene fluoride and hexafluoropropylene.

The object of the present invention and its technical problems are also achieved by adopting the following technical solutions. According to the present invention, a method for preparing an electrolyte material as described above includes the following steps:

(a) Pour different kinds of polymer material powder into N, N-dimethylformamide, and stir to obtain solution A;

(b) Pour different kinds of functional metal-organic frame material powders into the above solution A, and stir to obtain solution B;

(c) Take a certain amount of the solution B obtained in the above step b into a syringe, and perform electrospinning to form a film under a certain electric field and injection rate; the said electric field intensity is 0.6-2 kV/cm, the injection rate is 0.8-2 mL/h, and the injection time is 2-8 hours; preferably, the said electric field intensity is 1-1.5 kV/cm, the injection rate is 1.2-1.5 mL/h, and the injection time is 3-5 hours;

(d) Take out the film-formed sample and dry it to obtain the solid electrolyte material.

With the above technical solution, the present invention (name) has at least the following advantages:

(1) The solid electrolyte material of the present invention is a solid electrolyte material obtained by blending functional MOFs with a polymer substrate into a film using electrospinning technology, which can significantly reduce the safety risk of the battery electrolyte and make the battery have excellent stability and security.

(2) MOFs have the advantages of a regular channel structure, controllable pore size, and large specific surface area. By orderly compounding with high ion conductivity polymer materials, the regular channel structure of MOFs particles and the high ion conductivity of the polymer substrate on-rate can realize the coupling of the two, enhance the Li⁺ conduction rate, and then improve the battery performance.

(3) The preparation method of the present invention has simple steps and high reproducibility, and is suitable for industrial production.

In summary, the special solid electrolyte material and its preparation method of the present invention provide a solid electrolyte material and its preparation method with excellent performance, which is more suitable for practical use and has industrial utilization value. It has many of the above advantages and practical values, and it is indeed an innovation without similar publication or use in similar preparation methods. It is a great improvement both in preparation method and function. Technically, it has made great progress and produced good and practical effects, and has several improved functions over the existing electrolyte materials and their preparation methods, so it is more suitable for practical use, and has extensive industrial use value. Sincerely, A new, progressive and practical new design.

The above description is only an overview of the technical solution of the present invention. In order to understand the technical means of the present invention more clearly and can be implemented in accordance with the content of the description, the following detailed description of the drawings and preferred embodiments of the present invention is as follows.

The specific preparation method and structure of the present invention are given in detail by the following examples.

### BRIEF DESCRIPTION OF FIGURES

FIG. 1 is the SEM image of ZIF-8(SO₃H)-PEO solid-state electrolyte in example 1.

FIG. 2 is the cross-sectional SEM image of ZIF-8(SO₃H)-PEO solid-state electrolyte in example 1.

FIG. 3 is the SEM image of ZIF-8(SO₃H, 10%)-PEO solid-state electrolyte in which the weight percentage of ZIF-8 in the whole electrolyte is 10% in example 2.

FIG. 4 is the SEM image of functionalized UIO-66 (SO₃H)/ZIF-8(SO₃H)-PEO mixed MOFs-based solid-state electrolyte in example 3.

FIG. 5 is the EIS results of the batteries in example 1 and comparative example 1.

FIG. 6 is the ion conductivity performance of the solid-state electrolytes in example 1 and comparative example 2.

FIG. 7 is the performance of the all-solid-state Li—S battery in example 1 and comparative example 2.

FIG. 8 is the stability performance of the all-solid-state Li—S battery in example 1 and comparative example 2.

FIG. 9 is the rate discharge curve of the all-solid-state Li-ion battery under 0.2 C CC/CV (constant current/constant voltage) charge to 4.2 V. Cut off 0.05 C; 0.2 C/0.5 C/1 C/1.5 C discharge from 4.2 V to 3.0 V.

FIG. 10 is the charge-discharge curve under 0.2 C CC/CV charge to 4.2V. Cut off 0.05 C; 0.2 C discharge from 4.2 V to 3.0 V.

FIG. 11 shows the standard charging and discharging curves of all-solid-state Li-ion battery at 0.2 C, the profile is 0.2 C CC/CV charge to 4.2V. Cut off 0.05 C; 0.2 C/0.5 C/1 C/1.5 C discharge from 4.2 V to 3.0 V.

### DETAILED DESCRIPTION OF THE PREFERRED EMBODIMENT

Hereinafter, the present invention will be described batteries in more detail based on examples. Meanwhile, the present invention is not interpreted to be limited thereto.

### Example 1

I. Production of Solid-State Electrolyte

Weigh polymer PEO powder and DMF 1.2 g, 5.4 g, respectively. Then the PEO powder was poured into the DMF solvent at room temperature, and stirring it for 5 hr at 80° C. to form a clear solution. The functionalized ZIF-8 powder of 0.018 g was added into the above solution, and stirring it for 8 hr at 80° C. to form a clear solution. The weight percentage of functionalized ZIF reaches 1.5%. That solution was poured into the syringe and removed the air bubble inside. Then started to electrospin for the rate of 1.2 mL/h and with the electric intensity of 1 kV/cm for 5 hours to form a solid film. The above film was dried at 80° C. to obtain the desired solid-state electrolyte.

II. Electrochemical Characterization of the Solid-State Electrolyte

The ion conductivity was tested at different temperatures.

III. Production of Li—S all-Solid-State Battery

Such electrolyte was then immersed in 70% S/CS2 solution at 155° C. for 6 hours to obtain carbonaceous fabrics, which were mixed with carbon black (wt.10%) and PVDF (10%) as the cathode material. Assembling it with Li metal and commercialized Celegard 2500 separator to Li—S battery. The battery performance was then tested at room temperature.

IV. Production of Li-Ion all-Solid-State Battery

The commercialized ternary cathode material of Nickel Cobalt Manganese (NCM523), graphite as the positive and negative electrode, respectively. While the obtained all-solid-state material is used as the electrolyte. The cell is assembled and tested under open air condition.

### Example 2

In Example 2, the weight percentage of functionalized MOFs in the whole solid-state electrolyte was adjusted.

I. Production of Solid-State Electrolyte

Weigh polymer PEO powder and DMF 1.2 g, 5.4 g, respectively. Then the PEO powder was poured into the DMF solvent at room temperature, and stirring it for 5 hr at 80° C. to form a clear solution. The functionalized ZIF-8 powder of 0.12 g was added into the above solution, and stirring it for 8 hr at 80° C. to form a clear solution. The weight percentage of functionalized ZIF reaches 10%. That solution was poured into the syringe and removed the air bubble inside. Then started to electrospin for the rate of 1.2 mL/h and with the electric intensity of 1 kV/cm for 5 hours to form a solid film. The above film was dried at 80° C. to obtain the desired solid-state electrolyte.

II. Electrochemical Characterization of the Solid-State Electrolyte

The ion conductivity was tested at different temperatures.

III. Production of Li—S Solid-State Battery

Such electrolyte was then immersed in 70% S/CS2 solution at 155° C. for 6 hours to obtain carbonaceous fabrics, which were mixed with carbon black (wt.10%) and PVDF (10%) as the cathode material. Assembling it with Li metal and commercialized Celegard 2500 separator to Li—S battery.

IV. The Performance of Li—S Solid-State Battery was Evaluated

The electrochemical characterization, rate performance and long-term cycling performance were then tested at room temperature.

V. Production of Li-Ion all-Solid-State Battery

The commercialized ternary cathode material of Nickel Cobalt Manganese (NCM523), graphite as the positive and negative electrode, respectively. While the obtained all-solid-state material is used as the electrolyte. The cell is assembled and tested under open air condition.

### Example 3

In Example 3, the kind number of functionalized MOFs in the whole solid-state electrolyte was adjusted.

I. Production of Solid-State Electrolyte

Weigh polymer PEO powder and DMF 1.2 g, 5.4 g, respectively. Then the PEO powder was poured into the DMF solvent at room temperature, and stirring it for 5 hr at 80° C. to form a clear solution. The functionalized ZIF-8 powder of 0.012 g and UIO-66 of 0.006 g were added into the above solution, and stirring it for 8 hr at 80° C. to form a clear solution. The weight percentage of functionalized ZIF reaches 10%. That solution was poured into the syringe and removed the air bubble inside. Then started to electrospin for the rate of 1.2 mL/h and with the electric intensity of 1 kV/cm for 5 hours to form a solid film. The above film was dried at 80° C. to obtain the desired solid-state electrolyte.

II. Electrochemical Characterization of the Solid-State Electrolyte

The ion conductivity was tested at different temperatures.

III. Production of Li—S Solid-State Battery

Such electrolyte was then immersed in 70% S/CS2 solution at 155° C. for 6 hours to obtain carbonaceous fabrics, which were mixed with carbon black (wt.10%) and PVDF (10%) as the cathode material. Assembling it with Li metal and commercialized Celegard 2500 separator to Li—S battery.

IV. The Performance of Li—S Solid-State Battery was Evaluated

The electrochemical characterization, rate performance and long-term cycling performance were then tested at room temperature.

V. Production of Li-Ion all-Solid-State Battery

The commercialized ternary cathode material of Nickel Cobalt Manganese (NCM523), graphite as the positive and negative electrode, respectively. While the obtained all-solid-state material is used as the electrolyte. The cell is assembled and tested under open air condition.

### Example 4

In Example 4, the electric intensity of the electrospining method was adjusted.

I. Production of Solid-State Electrolyte

Weigh polymer PEO powder and DMF 1.2 g, 5.4 g, respectively. Then the PEO powder was poured into the DMF solvent at room temperature, and stirring it for 5 hr at 80° C. to form a clear solution. The functionalized ZIF-8 powder of 0.018 g was added into the above solution, and stirring it for 8 hr at 80° C. to form a clear solution. The weight percentage of functionalized ZIF reaches 1.5%. That solution was poured into the syringe and removed the air bubble inside. Then started to electrospin for the rate of 1.2 mL/h and with the electric intensity of 1.5 kV/cm for 5 hours to form a solid film. The above film was dried at 80° C. to obtain the desired solid-state electrolyte.

II. Electrochemical Characterization of the Solid-State Electrolyte

The ion conductivity was tested at different temperatures.

III. Production of Li—S Solid-State Battery

Such electrolyte was then immersed in 70% S/CS2 solution at 155° C. for 6 hours to obtain carbonaceous fabrics, which were mixed with carbon black (wt.10%) and PVDF (10%) as the cathode material. Assembling it with Li metal and commercialized Celegard 2500 separator to Li—S battery. The battery performance was then tested at room temperature.

IV. Production of Li-Ion all-Solid-State Battery

The commercialized ternary cathode material of Nickel Cobalt Manganese (NCM523), graphite as the positive and negative electrode, respectively. While the obtained all-solid-state material is used as the electrolyte. The cell is assembled and tested under open air condition.

### Example 5

In Example 5, the electrospinning rate of the electrospining method was adjusted.

I. Production of Solid-State Electrolyte

Weigh polymer PEO powder and DMF 1.2 g, 5.4 g, respectively. Then the PEO powder was poured into the DMF solvent at room temperature, and stirring it for 5 hr at 80° C. to form a clear solution. The functionalized ZIF-8 powder of 0.018 g was added into the above solution, and stirring it for 8 hours at 80° C. to form a clear solution. The weight percentage of functionalized ZIF reaches 1.5%. That solution was poured into the syringe and removed the air bubble inside. Then started to electrospin for the rate of 1.5 mL/h and with the electric intensity of 1.5 kV/cm for 5 hours to form a solid film. The above film was dried at 80° C. to obtain the desired solid-state electrolyte.

II. Electrochemical Characterization of the Solid-State Electrolyte

The ion conductivity was tested at different temperatures.

III. Production of Li—S Solid-State Battery

Such electrolyte was then immersed in 70% S/CS2 solution at 155° C. for 6 hours to obtain carbonaceous fabrics, which were mixed with carbon black (wt.10%) and PVDF (10%) as the cathode material.

Assembling it with Li metal and commercialized Celegard 2500 separator to Li—S battery. The battery performance was then tested at room temperature.

IV. Production of Li-Ion all-Solid-State Battery

The commercialized ternary cathode material of Nickel Cobalt Manganese (NCM523), graphite as the positive and negative electrode, respectively. While the obtained all-solid-state material is used as the electrolyte. The cell is assembled and tested under open air condition.

### Comparative Example 1

The solid-state electrolyte is produced in the same manner as in the Example 1 except that the functionalized MOFs used in the Example 1 was not used.

### Comparative Example 2

The CR2032 coin cells were assembled by using sulfur composite (S and Li2S, 1:1 by mole) electrode as cathode, Celgard 2500 membrane as separator, and lithium foil as anode in Ar-filled glove box with moisture and oxygen level lower than 0.5 ppm. The electrolyte contains 1M lithium bis(trifluoromethane) sulfonamide (LiTFSI) in a binary solvent of dimethoxymethane/1,3-dioxolane (DME/DOL, 1:1 by volume) with 2 wt. % LiNO3 as additive.

FIG. 1 is the scheme of the functionalized MOFs.

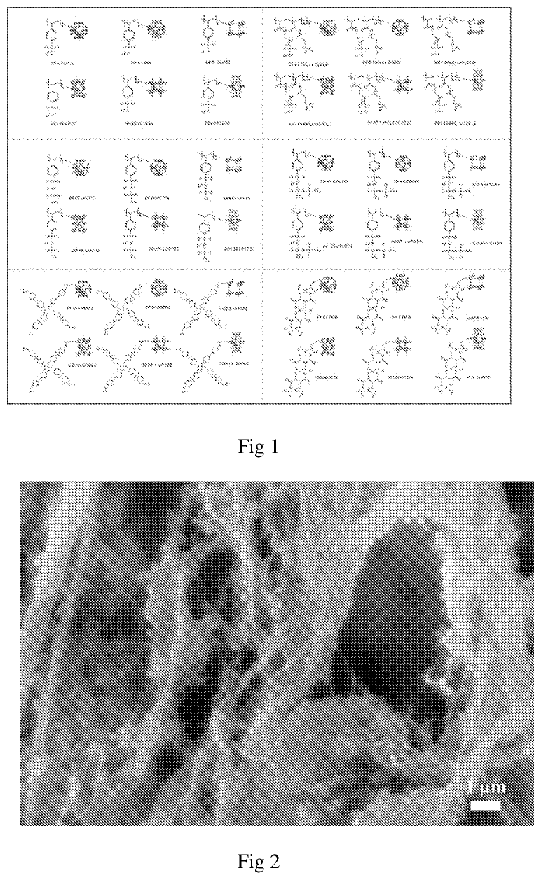

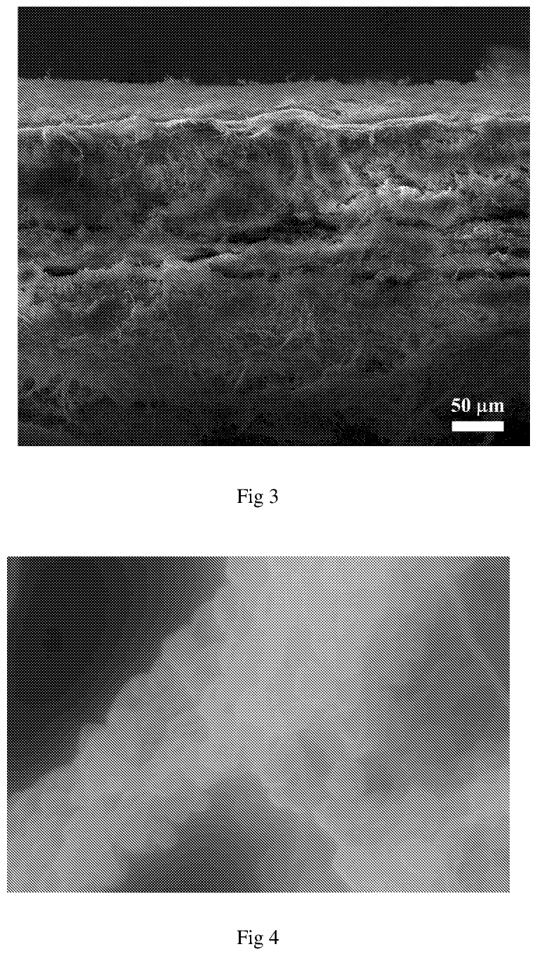

FIG. 2 shows that the functionalized ZIF-8-PEO solid-state electrolyte in present invention uniformly disperses on the fibers of PEO polymer, indicating the electrospinning method can mix the two composites well.

FIG. 3 shows that the thickness of functionalized ZIF-8-PEO solid-state electrolyte is 320 um.

FIG. 4 shows that the functionalized ZIF-8 particles mostly distribute on the PEO polymer fibers, indicating the weigh percentage is a little bit high.

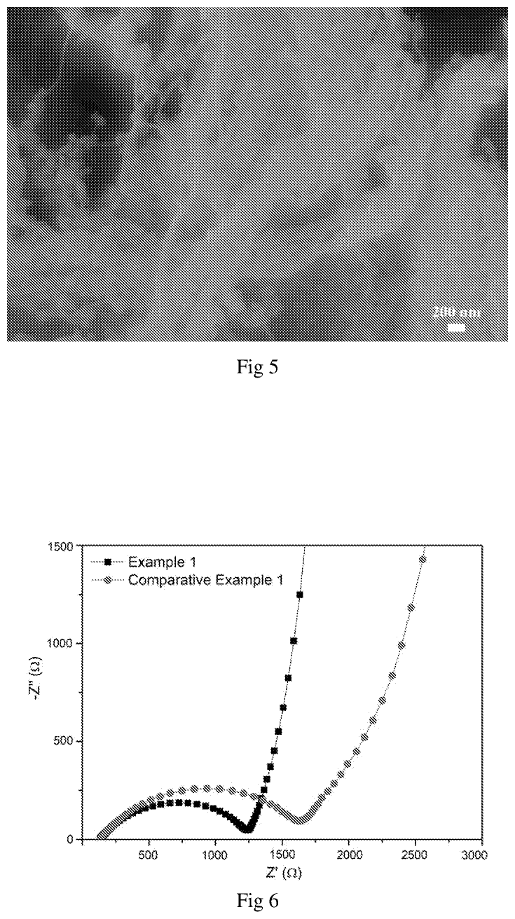

FIG. 5 shows that the functionalized UIO-66 and functionalized to ZIF-8 particles were distributed uniformly on the PEO polymer fibers.

FIG. 6 shows that the battery resistance in Example 1 and Comparative Example 1 was 1250Ω, 1650Ω, respectively, indicating that the existence of functionalized MOFs particles is beneficial for reducing the resistance and improving the Li+ ion conductivity.

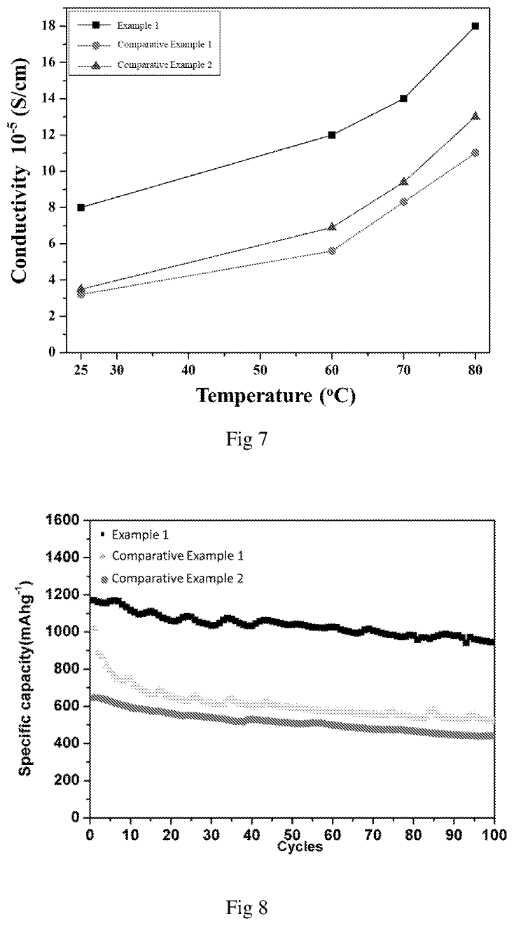

FIG. 7 shows that the ion conductivities at 25° C., 60° C., 70° C., 80° C. in Example 1 are higher than that in Comparative Example 1 and Comparative Example 2, demonstrating the ion conductivity is excellent in Example 1. It should be noted that the highest ion conductivity reaches as high as 0.18 mS/cm, showing the potential for commercialization.

FIG. 8 shows that the rate discharge curves at 0.1 C, 0.2 C, 0.5 C, 1 C in Example 1 are higher than that in Comparative Example 1 and Comparative Example 2. In addition, the performance when recycling at 0.1 C remains 93.1%, compared to that is only 77.2%, 73.6% in Comparative Example 1 and Comparative Example 2, respectively.

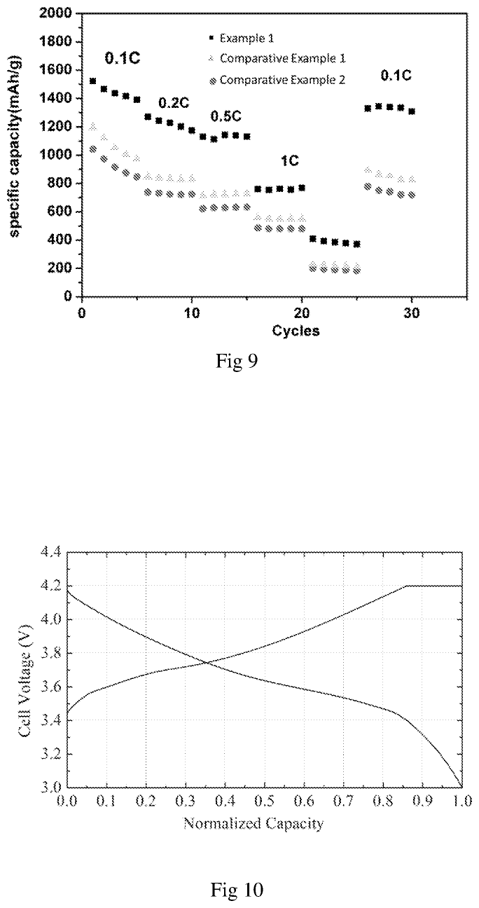

The charge-discharge curves of the all-solid-state Li—S battery in Example 1 is shown in FIG. 9. The results show the excellent cycling stability of the solid-state electrolyte with a high capacity retention of 83.3% even after 100 cycles, while it is only 69.2%, 52% in Comparative Example 1 and Comparative Example 2, respectively.

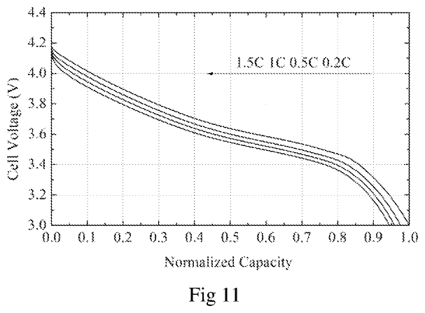

FIG. 10 shows the standard charging and discharging curves of all-solid-state Li-ion battery at 0.2 C, the profile is 0.2 C CC/CV (constant current/constant voltage) charge to 4.2V. Cut off 0.05 C; 0.2 C discharge from 4.2 V to 3.0 V.

FIG. 11 shows the standard charging and discharging curves of all-solid-state Li-ion battery at 0.2 C, the profile is 0.2 C CC/CV charge to 4.2V. Cut off 0.05 C; 0.2 C/0.5 C/1 C/1.5 C discharge from 4.2 V to 3.0 V.

1. An all-solid-state electrolyte composition for a secondary Li battery comprising: (a) functionalized MOFs; and (b) a polymer electrolyte.

2. The all-solid-state electrolyte composition of claim 1, wherein a weight percentage of the functionalized MOFs is 0.1%-20%, and the weight percentage of the polymer electrolyte is 80%-99.9%.

3. The all-solid-state electrolyte composition of claim 1, wherein the functionalized MOFs are selected from at least one of ZIF-8, ZIF-67, MOF-5, UIO-66, UIO-67, MIL-100 (Fe), MIL-53 (Al), DUT-5, DUT-4, MIL-101 (Cr), MIL-10INDC, HKUST-1 and PCN-14.

4. The all-solid-state electrolyte composition of claim 1, wherein functionalized groups for MOFs are selected from at least one of sulfonates, sulfonylimides, tetrahedral borates, and their derivatives.

5. The all-solid-state electrolyte composition of claim 1, wherein the polymer is selected from at least one of Polyethylene oxide (PEO), polymethyl methacrylate (PMMA), polyacrylonitrile (PAN), polyvinylidene difluoride (PVDF), polyvinylidene fluoride-hexafluoropropylene (PVDF-HFP) and their derivates.

6. The all-solid-state electrolyte composition of claim 1, wherein a type of the functionalized MOFs is one or two.

7. The all-solid-state electrolyte composition of claim 1, wherein the polymer electrolyte composite is selected from pure PEO or mixtures of PEO and another kind of polymer.

8. The all-solid-state electrolyte composition of claim 1, wherein the weight percentage of the functionalized MOFs ranges from 1.5% to 10%.

9. A process for manufacturing the all-solid-state electrolyte composition according to claim 1, wherein the process comprises:
(a) pouring a certain amount of polymer powder into a Dimethylformamide (DMF) solvent at room temperature, and stirring it for 5-90 hours at 60-100° C. to form a clear solution A;
(b) adding a certain amount of MOFs powder into the solution A, and stirring it for 8-90 hours at 50-100° C. to form a clear solution B;
(c) pouring the solution B into a syringe and removing the air inside, then starting to electrospin at a certain rate and electric intensity to form a solid film;
(d) drying the solid film at 60-100° C. to obtain the desired solid-state electrolyte.

10. The process for manufacturing the all-solid-state electrolyte composition of claim 9, wherein the electric intensity, injection rate and the injection time in procedure (c) range from 1 to 1.5 kV/cm, 1.2-1.5 mL/h and 3-5 hours, respectively.

11. The all-solid-state electrolyte composition of claim 3, wherein a type of the functionalized MOFs is one or two.

12. The all-solid-state electrolyte composition of claim 4, wherein the polymer electrolyte composite is selected from pure PEO or mixtures of PEO and another kind of polymer.

13. The all-solid-state electrolyte composition of claim 3, wherein the weight percentage of the functionalized MOFs ranges from 1.5% to 10%.
